(19) United States
(12) Patent Application Publication
(10) Pub. No.: US 2014/0337122 A1
(43) Pub. Date: Nov. 13, 2014

(54) GENERATING RETAIL PROMOTION BASELINES

(71) Applicant: Oracle International Corporation, Redwood Shores, CA (US)

(72) Inventors: Neha BANSAL, Plymouth, MN (US); Michael R. BESSE, Assonet, MA (US); Ramon RAMIREZ, East Freetown, MA (US)

(73) Assignee: Oracle International Corporation, Redwood Shores, CA (US)

(21) Appl. No.: 13/891,761

(22) Filed: May 10, 2013

(51) Int. Cl. G06Q 30/02

(52) U.S. Cl. CPC G06Q 30/0246
USPC 705/14.45

(57) ABSTRACT

A system for generating a retail promotion baseline receives sales data for a target product. The sales data reflects sales for the target product that occurred during a first time period and a second time period, the first time period occurring before the promotion, and the second time period occurring after the promotion. The system exponentially weights the sales data. The sales data reflect sales which occurred closer to the promotion is weighted more heavily than the sales data reflecting sales which occurred further from the promotion. The system calculates the retail promotion baseline based upon the exponentially weighted sales data. The retail promotion baseline corresponds to an amount of sales for the product absent the promotion for the product.

### FIELD

One embodiment is directed generally to a computer system, and in particular to a computer system that generates retail promotion baselines.

### BACKGROUND INFORMATION

Retail promotions are generally considered to be different actions taken by retailers that attempt to incentivize customers to purchase products. Specifically, retail promotions may attempt to increase product interest or encourage product trial, for example. A retailer may distribute coupons, distribute samples, sponsor contests, distribute rebates, and sponsor sweepstakes during a promotion, for example.

In order to determine whether a retail promotion is necessary, and also to determine how extensive a necessary retail promotion should be, retailers may examine certain calculated retail promotion baselines to make these determinations. A retail promotion baseline for a product can generally be considered an amount of sales for the product that would occur without any retail promotion for the product. Therefore, if a retail promotion baseline for a product is high, the product may require only a relatively small amount of retail promotion activity, if any at all, to meet a sales target for the product. On the other hand, if the retail promotion baseline for the product is low, the product may need an extensive retail promotion in order for the product to meet the sales target for the product. Therefore, after referring to a calculated retail promotion baseline of a product, a retailer may make more informed decisions on when and how to implement retail promotions for the product.

### SUMMARY

One embodiment is a system for generating a retail promotion baseline. The system receives historical sales data for a target product. The sales data reflects sales for the target product that occurred during a first time period and a second time period, the first time period occurring before a promotion, and the second time period occurring after the promotion. The system exponentially weights the sales data. The sales data reflecting sales which occurred closer to the promotion is weighted more heavily than the sales data reflecting sales which occurred further from the promotion. The system calculates the retail promotion baseline based upon the exponentially weighted sales data. The retail promotion baseline corresponds to an amount of sales for the product that would occur without the promotion for the product.

### BRIEF DESCRIPTION OF THE DRAWINGS

FIG. 1 is an overview block diagram of a computer system for generating a retail promotion baseline in accordance with an embodiment of the present invention.

FIG. 2 illustrates data for generating a retail promotion baseline in accordance with an embodiment of the present invention.

FIG. 3 illustrates configuration parameters in accordance with an embodiment of the present invention.

FIG. 4 is a flow diagram of the functionality of the generating retail promotion baseline module of FIG. 1 in accordance with one embodiment.

### DETAILED DESCRIPTION

One embodiment of the present invention is directed to a data-driven analytical approach that applies data mining techniques to generate a retail promotion baseline relating to a retail promotion. As discussed above, a retail promotion baseline can be generally considered a benchmark corresponding to an amount of sales for a product that would occur without a retail promotion for the product. A retail promotion baseline can also be a benchmark corresponding to an amount of sales for a targeted category of products that would occur without a retail promotion for the category of products. As described in more detail below, in one embodiment, a retail promotion baseline is generated based on processed/historical sales data for products. The sales data of a product can reflect the sales which occur during a first specified period of time before a promotion begins (e.g., sales which occurred during a first specified number of weeks leading up to the promotion), and the sales data of a product can also reflect the sales which occur during a second specified period of time after a promotion (e.g., sales which occurred during a second specified number of weeks after the promotion ends).

Known retail systems generally generate retail promotion baselines for products by first collecting sales data relating to products and then performing linear calculations on the sales data for the products. As an example of performing linear calculations on sales data, the known systems may receive sales data for a product over a time period, and then perform a straightforward calculation by dividing the total amount of sales over the length of the time period to calculate an average amount of sales for each unit of time of the time period. As such, all portions of the sales data would generally be weighted the same (i.e., all portions of the sales data would all equally contribute) when determining the retail promotion baseline. In other words, all portions of the sales data generally have equal significance when determining the retail promotion baselines.

Further, the known systems generally generate baselines using sales data that is aggregated by product brand. Specifically, the known systems generally collect sales data that is related to how each brand is selling, as opposed to collecting data relating to how each product is selling.

In contrast with the known retail systems, one embodiment of the present invention receives sales data for a target product and generates a retail promotion baseline for the product by performing exponential calculations on the sales data. For example, in one embodiment that performs exponential calculations on the sales data, sales that occurred during time periods closer to the promotion are weighted more heavily (and thus contribute more) when generating the promotion's baseline as compared to sales that occur during time periods that are further from the promotion. In other words, in one embodiment, more emphasis is placed upon the sales data corresponding to the weeks immediately preceding or immediately after the promotion. Further, in contrast to the known systems, one embodiment also generates baselines for each individual product item as opposed to an entire brand.

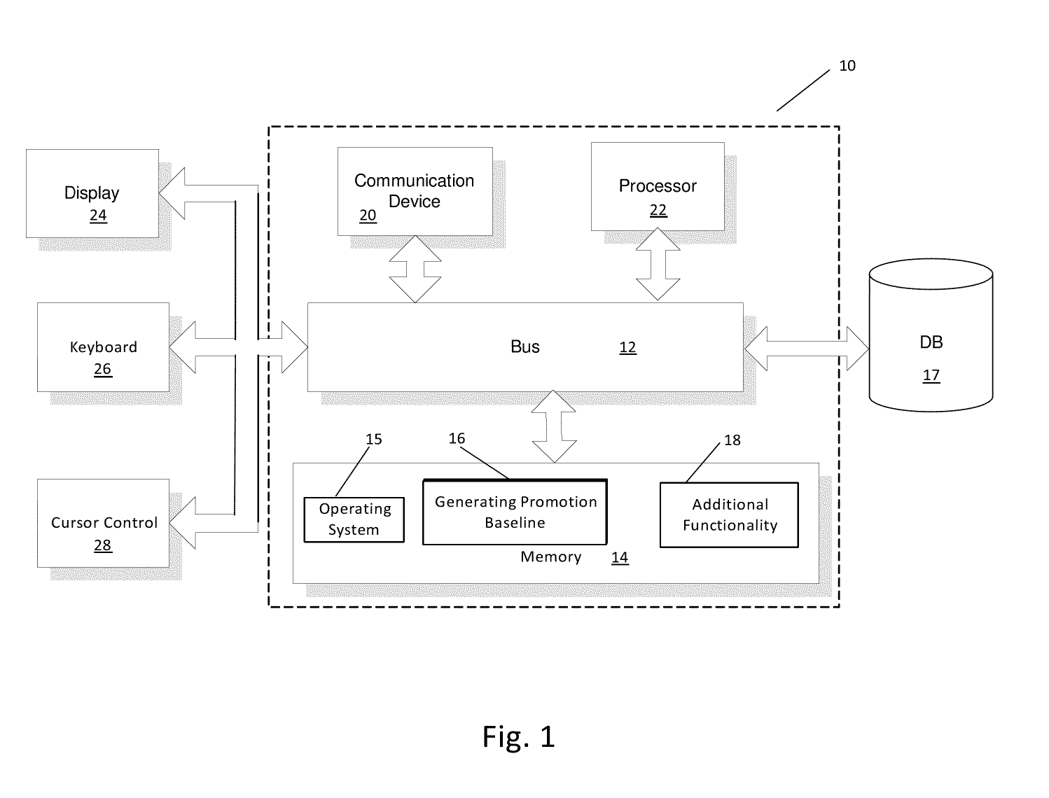

FIG. 1 is an overview block diagram of a computer system 10 for generating retail promotion baselines in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 may be further coupled via bus 12 to a display 24, such as a Liquid Crystal Display (“LCD”). A keyboard 26 and a cursor control device 28, such as a computer mouse, may be further coupled to bus 12 to enable a user to interface with system 10.

In one embodiment, memory 14 stores software modules that provide functionality when executed by processor 22. The modules include an operating system 15 that provides operating system functionality for system 10. The modules further includes a generating retail promotion baseline module 16 that allows a user to generate retail promotion baselines for a product or a category of products, as disclosed in more detail below. System 10 can be part of a larger system such as “Oracle Retail Merchandising Analytics” from Oracle Corporation. Therefore, system 10 will typically include one or more additional functional modules 18 to include additional functionality, such as data processing functionality for receiving and organizing sales data. A database 17 is coupled to bus 12 to store data used with modules 16 and 18.

As described above, retailers may use promotions to boost sales, create product awareness, and strategically increase sales and profit for a targeted product or a targeted category of products. When a promotion begins, the amount of sales for a targeted product is expected to first increase. When the promotion ends, the amount of sales for the targeted product is then expected to decrease. In view of the rising and falling of sales, retailers can use retail promotion baselines to plan promotions to achieve an amount of expected sales for the targeted products. For example, retailers can use retail promotion baselines to identify an estimated level of promotion that should be directed to a targeted product so that the retailers can meet sales targets for the targeted product. By examining a retail promotion baseline, a retailer may decide that a sales target can be reached without using promotions, or by promoting very little, thus allowing the retailer to more strategically implement promotions. Further, once a retail promotion baseline of a target product is generated, retailers can examine the difference between the sales which actually occur during a promotion for the target product and the corresponding generated retail promotion baseline for the target product. A positive difference may be considered to be the additional amount of sales which occur as a result of the promotion. The positive gains in sales resulting from the promotion may be generally referred to as the “sales lift” provided by the promotion.

In the event that an actual amount of sales for a target product during a promotion period largely exceeds its corresponding retail promotion baseline, and the retail promotion baseline for the product is low, a retailer may be able to reach the conclusion that customers are shopping for the targeted product exclusively during the promotion period. Under such circumstances, retailers may decide to cut back on the number of promotions or restructure the promotions for the target product in order to avoid conditioning customers to buying the target product during only the time when the target product is on promotion. On the other hand, if a difference between an actual amount of sales for a target product and its retail promotion baseline is small, retailers may reach the conclusion that the promotions for the target product are not effective and are not worth the cost to run them.

As described above, in one embodiment, a retail promotion baseline is generated based on sales data of a product that: (1) reflects the sales which occurred during a first specified period of time before a promotion begins and/or (2) reflects the sales which occurred during a second specified period of time after a promotion ends. One embodiment allows a user to determine the lengths of the first and second specified time periods (before and after a promotion). The embodiment then generates the retail promotion baseline for the product based upon the sales data corresponding to these specified time periods. In one embodiment, the time periods can be measured in terms of weeks. The total number/range of weeks can be split before and after the promotion in accordance to the user's preferences.

The number of weeks of sales data to be used when generating a retail promotion baseline can be configurable and, by default, the number of weeks can be split evenly before and after the promotion. In another embodiment, the number of weeks can be configured to place more emphasis on either side of the promotion. For example, if a user decides to use 16 weeks of sales data, the user can use 10 pre-promotion weeks and 6 post-promotion weeks to generate the retail promotion baseline.

In one embodiment, a retail promotion baseline for a product can be generated/regenerated as new sales data becomes available. For example, suppose that a user determines that a retail promotion baseline is to be based upon sales data reflecting sales in: (1) the 10 weeks prior to a promotion (a first specified time period), and (2) the 10 weeks after the promotion (a second specified time period). As such, even before the promotion starts, starting from 10 weeks prior to the promotion, as soon as any sales data is received, a user can generate retail promotion baselines based on the available data. Once the promotion ends, the user can generate retail promotion baselines based on the available data from the full 10 weeks prior to the promotion as well as any sales data available after the promotion. After the full 10 weeks have elapsed after the promotion, the user can generate retail promotion baselines based on the entire available data from both the first specified time period and the second specified time period.

As described above, the retail promotion baseline can be generated based upon sales data that reflects sales that occur in weeks preceding a promotion and/or weeks after the promotion. As more and more sales data is incorporated into the calculation of the retail promotion baseline, the retail promotion baseline can be recalculated/refreshed. Additionally, in one embodiment, a user can set a parameter to indicate a frequency at which a retail promotion baseline is refreshed. For example, if the user sets the parameter to a value of “one,” the retail promotion baseline is recalculated every week. If the user sets the parameter to a value of “two,” the retail promotion baseline is recalculated every two weeks. If the user sets the parameter to a value of “zero,” the retail promotion baseline is not recalculated. In view of the above, as discussed above, embodiments of the present invention provide users with the benefit of seeing generated retail promotion baselines before, during, and after a promotion.

Because calculating a retail promotion baseline can require the processing of several weeks of sales data, the calculation of the retail promotion baseline may require substantial processing resources/time. However, in one embodiment, the sales data is stored in the database at a weekly aggregation level (i.e., the data is grouped according to the week in which the data was collected), and the retail promotion baseline is recalculated/refreshed in a manner that may require less resources/time. In one embodiment, when the retail promotion baseline is refreshed, processing resources are generally devoted to processing the new aggregation data which was received after the retail promotion baseline was last generated. Processing resources are generally not devoted to processing the data corresponding to previously aggregated weeks, which were already been processed the last time the retail promotion baseline was generated. Thus, by reducing the amount of processing resources devoted to processing data that does not change (i.e., data of the previously aggregated weeks), one embodiment generates retail promotion baselines using less resources/time.

In one embodiment, by referencing a generated retail promotion baseline, users can see preliminary performance metrics of a promotion (by comparing the actual sales data of the promotion to retail promotion baselines generated based on the available data). Users can review the performance metrics of a promotion, from the beginning of a promotion all the way through the “post-promotion” configured number of weeks.

With embodiments that generate a retail promotion baseline for an entire category of products, if a product within the category of products is currently on promotion, the sales data for the product currently on promotion can be excluded from the calculations used to generate the retail promotion baseline for the category because the item on promotion has already experienced sales lift as a result of the promotion. Because including an item that has already experienced sales lift when generating the retail promotion baseline for the category would result in calculating an erroneous baseline for the category, certain embodiments do not include sales data corresponding to the time in which the item was on promotion. In other words, sales data corresponding to products and weeks that are influenced by promotions can be excluded from the calculation of a baseline.

In another embodiment, non-existent weekly sales are also incorporated into the calculations used to generate a retail promotion baseline. For example, if the sales data for a specific week reflects no sales for a product, the sales data will be considered as zero sales, as opposed to not being used at all. Therefore, non-existent sales tend to lower the calculated retail promotion baseline.

In one embodiment, in contrast to the known systems of using linear calculations to generate retail promotion baselines, one embodiment of the present invention generates retail promotion baselines by performing calculations that exponentially-weight sales data. For example, the sales data can be given a weight of (p/m)̂n, with “n” being based on an amount of time that has elapsed between the promotion and the time in which the sales for the sales data occurred. “p/m” can also be referred to as a weighting coefficient. “m” and “p” can correspond to any numerals that allow for proper weighting of the sales data. For example, suppose that the user determines that “m” is to be 2 and “p” is to be 1, and sales data is collected during the week immediately before or after the promotion (i.e., no time has elapsed between the promotion and the time in which the sales occurred). In this example, because the sales data is collected immediately before or after the promotion, “n” would then be “0” to reflect that no time has passed between the promotional week and the time in which the sales occurred. For the sales data collected during these weeks, the sales data would then be weighted by “1” (i.e., (½)̂0). If sales data is collected during the week beginning two weeks before the promotion, the sales data would then be weighted by “½” (i.e., (½)̂1, “n” is 1 because the sales data is 1 week removed from being an adjacent week to the sales promotion). As described above, the (p/m) base weight is configurable according to how the user would like to slow down or accelerate the “aging weight process” for surrounding weeks.

In one embodiment, a formula for calculating a retail promotion baseline is as follows:

$$Baseline = \frac{{\sum }_{d} s * {w}^{( d - 1 )}}{{\sum }_{d} {w}^{( d - 1 )}} \qquad ( 1 )$$

In this embodiment, “s” corresponds to an amount of sales units for a non-promoted week, “w” corresponds to a weighting coefficient for exponential smoothing, “d” corresponds to a distance in time from the time of the promotion. As described above, “w” can expressed as (p/m). “d” can represent a number of weeks before the promotion or a number of weeks that have elapsed since the promotion. In one embodiment, “n” as described above, can be related to “d” by the relationship “n=d−1.” In one embodiment, the equation uses data from weeks that are non-promotional weeks for the relevant item.

Customers may purchase an increased amount of retail products during promotions, but the customers may also decide to return some of the retail products that they purchased during the promotions. In one embodiment, the returns of customers are not given special consideration when generating a retail promotion baseline. Therefore, in one embodiment, the returning of retail products purchased during a promotion, or absent a promotion, will not affect the generated retail promotion baseline.

One embodiment allows a user to examine sales data for each product, as opposed to merely examining sales data for each brand of products. As the sales data becomes more detailed and complicated, performing calculations to refresh a retail promotion baseline becomes more expensive in terms of the use of processing resources. As such, one embodiment controls the amount of weeks to refresh, minimizes the amount of weeks to recalculate, and/or uses partial results in order to save on processing resources.

One embodiment of the present invention retrieves sales transaction data from a retail analytics (“RA”) data warehouse that stores data and performs calculations to generate retail promotion baselines based on the retrieved data. In one embodiment, a process first transfers sales data by week, identifying which weeks are suitable to be included for calculating a retail promotion baseline. As described above, as compared to the known systems, an advantage provided by one embodiment of the present invention is that retail promotion baselines can be generated by using less processing resources. Users of the present invention can then use the generated retail promotion baselines to facilitate comparisons of promotional sales to baseline sales and thus measure promotion effectiveness.

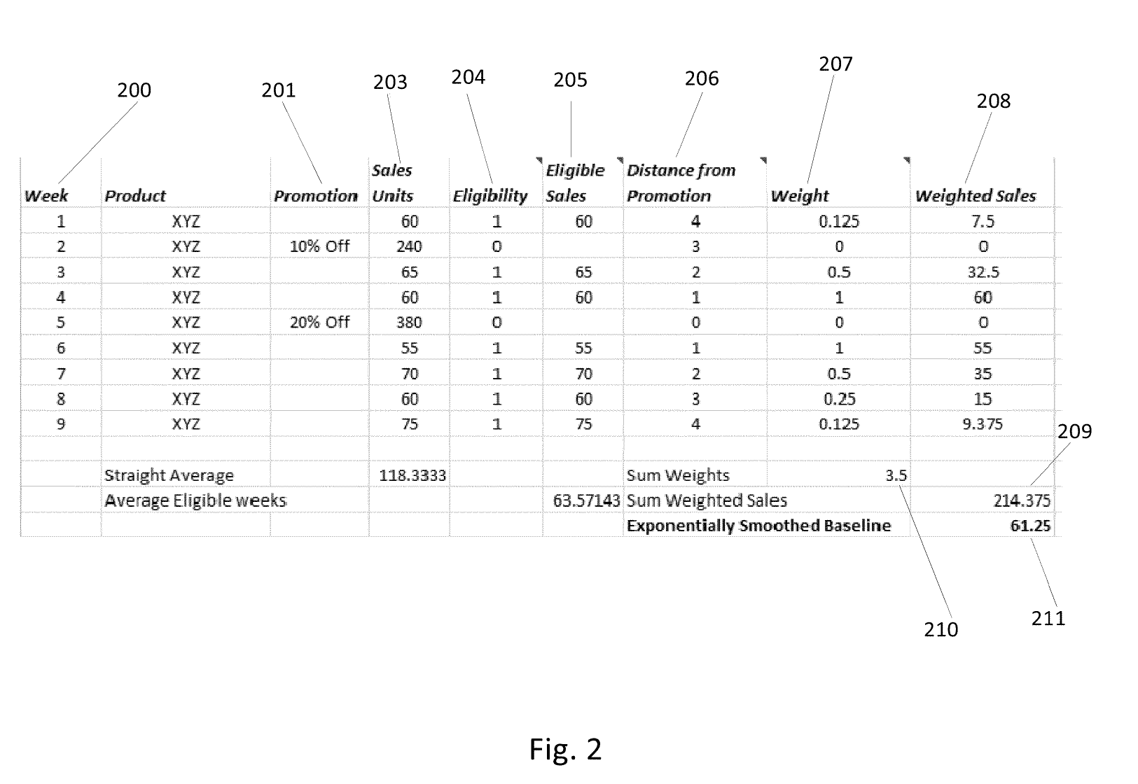

FIG. 2 illustrates data (columns 203-208) for generating a retail promotion baseline 211 in accordance with an embodiment of the present invention. Column 200 shows the weeks from which data is used to generate the retail promotion baseline 211. Specifically, column 200 shows that data from weeks 1-9 is used to generate the retail promotion baseline 211. Column 201 shows the promotions that occurred during weeks 1-9. Specifically, in this example, column 201 shows that a 10% promotion occurred during week 2 and a 20% promotion occurred during week 5.

Column 203 shows the sales that occurred during each of weeks 1-9. In this example, because promotions occurred during weeks 2 and 5, weeks 2 and 5 have more corresponding sales compared to the other weeks. Column 204 shows which sales data is eligible to be used for generating the promotion baseline 211. As described above, in one embodiment, sales data for products that are promoted can be excluded from the calculations used to generate the promotion baseline 211. Therefore, because promotions occurred during weeks 2 and 5, column 204 indicates that the sales data from weeks 2 and 5 is ineligible (weeks 2 and 5 have eligibility “0”) to be used to generate the promotion baseline 211. On the other hand, column 204 indicates that sales data from weeks 1, 3, 4, and 6-9 is eligible (these weeks have eligibility “1”) to be used to generate the promotion baseline 211. Column 205 reflects the eligible sales data for each week.

Column 206 shows the distances in time of the sales data from the promotion of interest. As described above, the distance can also be referred to as “d.” In this example, the 20% promotion of week 5 is the specific promotion of interest. Therefore, column 206 shows that the sales data from weeks 4 and 6 is adjacent to the 20% promotion of week 5. Column 207 shows how to exponentially weight the sales data. As described above, a promotion baseline can be determined based upon ŵ(d-1), where “w” corresponds to a weighting coefficient for exponential smoothing. In this example, assuming the weighting coefficient is (½), column 207 shows the exponential weighting of the sales data for each of weeks 1-9. Referring to week 3, week 3 has a distance of “2” from the week 5 promotion (i.e., d=2). Therefore, the exponential weighting for the sales data of week 3 is 0.5, which corresponds to (½)̂(2−1). Column 208 shows the weighted sales which are calculated by multiplying the eligible sales of column 205 with the exponential weighting of column 207.

Finally, retail promotion baseline 211 can be calculated using formula (1), described above. The sum-of-the-weighted-sales 209 is divided by sum-of-weights 210 to determine retail promotion baseline 211.

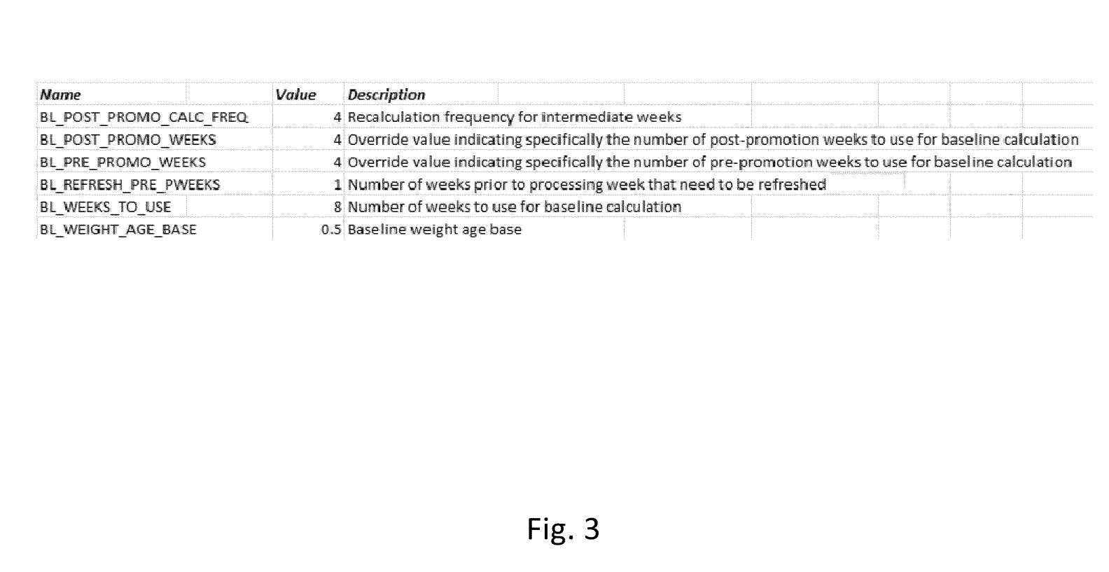

FIG. 3 illustrates configuration parameters in accordance with an embodiment of the present invention. As described above, one embodiment allows a user to configure how many pre-promotion weeks to use and how many post-promotion weeks to use for generating the retail promotion baseline. Parameter “BL_POST_PROMO_CALC_FREQ” can be configured/modified to determine a frequency to calculate/recalculate the retail promotion baseline. For example, if “BL_POST_PROMO_CALC_FREQ” is set to “1,” the retail promotion baseline is calculated/recalculated each week. If this parameter is set to “2,” the retail promotion baseline is calculated/recalculated once every two weeks. Parameter “BL_POST_PROMO_WEEKS” can be configured/modified to determine the number of post-promotion weeks to use to generate the retail promotion baseline. Parameter “BL_PRE_PROMO_WEEKS” can be configured/modified to determine the number of pre-promotion weeks to use to generate the retail promotion baseline. Parameter “BL_REFRESH_PRE_PWEEKS” can be configured/modified to determine a number of weeks of sales data to refresh for purposes of generating the retail promotion baseline. Parameter “BL_WEEKS_TO_USE” can be configured/modified to determine the number of weeks of sales data to use for generating the retail promotion baseline. Parameter “BL_WEIGHT_AGE_BASE” can be configured/modified to determine the weighting coefficient.

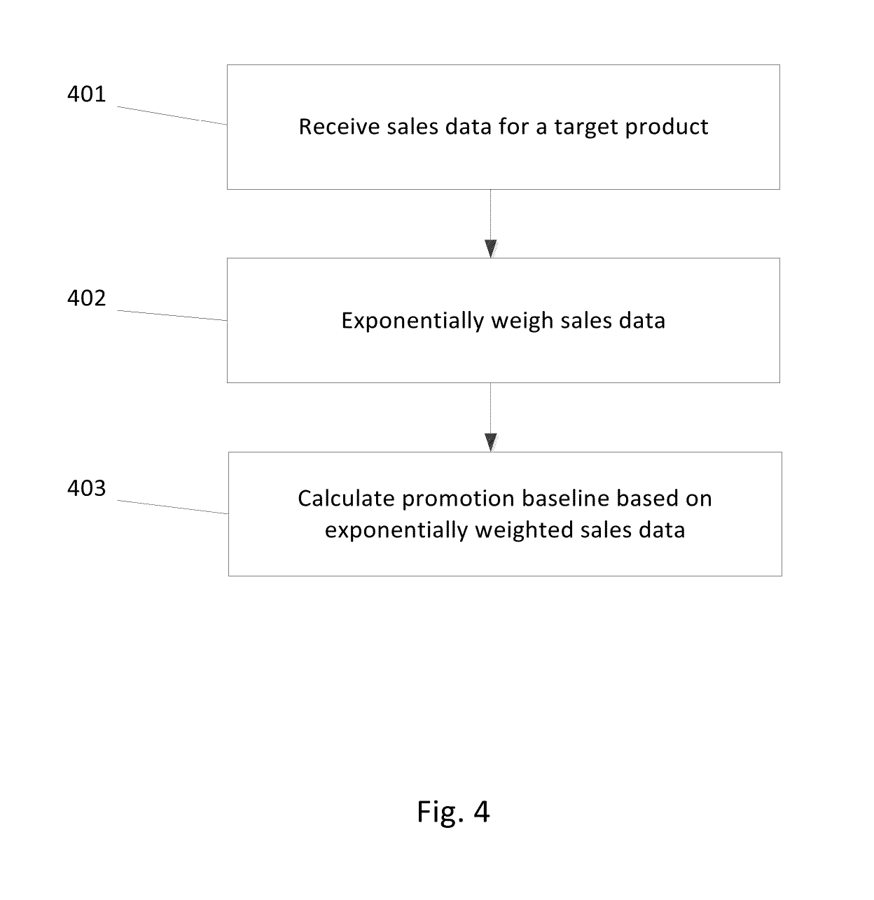

FIG. 4 is a flow diagram of the functionality of the generating retail promotion baseline module 16 of FIG. 1 in accordance with one embodiment. In one embodiment, the functionality of the flow diagram of FIG. 4 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 401, sales data for a target product is received. In one embodiment, as described above, the sales data reflects sales for the target product that occurred during a first time period and a second time period. The first time period occurs before the promotion. The second time period occurs after the promotion. As described above, the number of weeks can be configured to place more emphasis on either side of the promotion. As described above, a retail promotion baseline for a product can be generated/regenerated as new sales data becomes available.

At 402, the sales data is exponentially weighted. In one embodiment, the sales data reflecting sales closer to the promotion is weighted more heavily than the sales data reflecting sales further from the promotion. As described above, in one embodiment, the sales data can be given a weight of (p/m)̂n, with “n” being based on an amount of time that has elapsed between the promotion and the time in which the sales for the sales data occurred, and “m” can correspond to any numeral that allows for proper weighting of the sales data. “P” can also correspond to being a numeral that allows for proper weighting of the sales data.

At 403, a retail promotion baseline is calculated based on the exponentially weighted sales data. As described above, in one embodiment, the retail promotion baseline corresponds to an amount of sales for the product absent the promotion for the product. As described above, a retail promotion baseline can be generally considered to be a benchmark corresponding to an amount of sales for a product that would occur without a retail promotion for the product.

As described above, certain embodiments receive sales data for a target product and generate a retail promotion baseline for the product by performing exponential calculations on the sales data. In one embodiment that performs exponential calculations on the sales data, sales that occurred during time periods closer to the promotion are weighted more heavily (and thus contribute more) when generating the promotion's baseline as compared to sales that occur during time periods that are further from the promotion.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to generate a retail promotion baseline, the generating comprising:
receiving sales data for a target product, wherein the sales data comprises sales for the target product that occurred during a first time period and a second time period, the first time period occurring before a promotion, and the second time period occurring after the promotion;
exponentially weighting the sales data, wherein the sales data reflecting sales which occurred closer to the promotion is weighted more heavily than the sales data reflecting sales which occurred further from the promotion; and
calculating the retail promotion baseline based upon the exponentially weighted sales data, wherein the retail promotion baseline corresponds to an amount of sales for the product absent the promotion for the product.

2. The computer readable medium of claim 1, wherein exponentially weighting the sales data comprises assigning weights corresponding to (p/m)̂n, wherein n is based on an amount of time that has elapsed between the promotion and the time in which the sales for the sales data occurred, m corresponds to a numeral that allows for proper weighting of the sales data, and p corresponds to another numeral that allows for proper weighting of the sales data.

3. The computer readable medium of claim 2, wherein n is based on a number of weeks after or before the promotion.

4. The computer readable medium of claim 1, wherein a length of the first time period is different than a length of the second time period.

5. The computer readable medium of claim 1, further comprising refreshing the retail promotion baseline.

6. The computer readable medium of claim 1, wherein a length of the first time period and a length of the second time period are defined by a user.

7. A method for generating a retail promotion baseline, the method comprising:
receiving sales data for a target product, wherein the sales data comprises sales for the target product that occurred during a first time period and a second time period, the first time period occurring before a promotion, and the second time period occurring after the promotion;
exponentially weighting the sales data, wherein the sales data reflecting sales which occurred closer to the promotion is weighted more heavily than the sales data reflecting sales which occurred further from the promotion; and
calculating the retail promotion baseline based upon the exponentially weighted sales data, wherein the retail promotion baseline corresponds to an amount of sales for the product absent the promotion for the product.

8. The method of claim 7, wherein exponentially weighting the sales data comprises assigning weights corresponding to (p/m)̂n, wherein n is based on an amount of time that has elapsed between the promotion and the time in which the sales for the sales data occurred, m corresponds to a numeral that allows for proper weighting of the sales data, and p corresponds to another numeral that allows for proper weighting of the sales data.

9. The method of claim 8, wherein n is based on a number of weeks after or before the promotion.

10. The method of claim 7, wherein a length of the first time period is different than a length of the second time period.

11. The method of claim 7, further comprising refreshing the retail promotion baseline.

12. The method of claim 7, wherein a length of the first time period and a length of the second time period are defined by a user.

13. A system for generating a retail promotion baseline, the system comprising:
a processor;
a memory coupled to the processor;
a receiving module that receives sales data for a target product, wherein the sales data comprises sales for the target product that occurred during a first time period and a second time period, the first time period occurring before a promotion, and the second time period occurring after the promotion;
a weighting module that exponentially weights the sales data, wherein the sales data reflecting sales which occurred closer to the promotion is weighted more heavily than the sales data reflecting sales which occurred further from the promotion; and
a calculating module that calculates the retail promotion baseline based upon the exponentially weighted sales data, wherein the retail promotion baseline corresponds to an amount of sales for the product absent the promotion for the product.

14. The system of claim 13, wherein exponentially weighting the sales data comprises assigning weights corresponding to (p/m)̂n, wherein n is based on an amount of time that has elapsed between the promotion and the time in which the sales for the sales data occurred, m corresponds to a numeral that allows for proper weighting of the sales data, and p corresponds to another numeral that allows for proper weighting of the sales data.

15. The system of claim 14, wherein n is based on a number of weeks after or before the promotion.

16. The system of claim 13, wherein a length of the first time period is different than the length of the second time period.

17. The system of claim 13, further comprising a refreshing module that refreshes the retail promotion baseline.

18. The system of claim 13, wherein a length of the first time period and the length of the second time period are defined by a user.

19. The computer readable medium of claim 1, wherein the sales data is stored at a weekly aggregation level.

20. The method of claim 7, wherein the sales data is stored at a weekly aggregation level.
